(19) United States
(12) Patent Application Publication
(10) Pub. No.: US 2025/0372960 A1
(43) Pub. Date: Dec. 4, 2025

(54) SPARK PLUG

(71) Applicant: Niterra Co., Ltd., Nagoya-shi (JP)

(72) Inventors: Susumu IMAI, Nagoya-shi (JP); Kaito NAKAMURA, Nagoya-shi (JP)

(73) Assignee: Niterra Co., Ltd., Nagoya-shi (JP)

(21) Appl. No.: 19/199,736

(22) Filed: May 6, 2025

(30) Foreign Application Priority Data
May 28, 2024 (JP) 2024-086531

(51) Int. Cl. H01T 13/52; H01T 13/06; H01T 13/32; H01T 13/34; H01T 13/39

(52) U.S. Cl. CPC H01T 13/52; H01T 13/06; H01T 13/32; H01T 13/34; H01T 13/39

(57) ABSTRACT

A spark plug includes a center electrode and a ground electrode that are electrically insulated. At least one of the center electrode and the ground electrode includes a chip containing Ru as a main constituent, and the chip includes a discharge surface facing another one of the center electrode and the ground electrode. When a first test line that is 10 μm away from the discharge surface is drawn on a cross-section of the chip, an average of the numbers of crystal grain boundaries of the chip, the crystal grain boundaries being intersected by the first test line, per unit length of the first test line is 20 pieces/mm or more and 400 pieces/mm or less, and an average of the lengths of circumferences of crystal grains intersected by the first test line is 6.5 μm or more and 320 μm or less.

### FIELD OF THE INVENTION

The present invention relates to a spark plug that includes a chip containing Ru.

### BACKGROUND OF THE INVENTION

Japanese Unexamined Patent Application Publication No. 5-54955 discloses a related art in which at least one of a center electrode and a ground electrode includes a chip constituted by a simple substance of Ru or a Ru alloy.

Since oxidized vapor of Ru is remarkable under high temperature, the chip of the related art easily wears out, and the service life of a spark plug may end prematurely.

### SUMMARY OF THE INVENTION

The present invention has been made to solve the above-referenced problem, and an object of the present invention is to provide a spark plug in which wear of a chip can be reduced.

A first aspect for achieving this object includes an insulator that has an axial hole extending along an axial line; a center electrode that is disposed in the axial hole; a metal shell that is disposed at an outer periphery of the insulator; and a ground electrode that is connected to the metal shell. At least one of the center electrode and the ground electrode includes a chip that contains Ru as a main constituent, and the chip includes a discharge surface that faces another one of the center electrode and the ground electrode in a direction along the axial line. When a first test line that is 10 μm away from the discharge surface is drawn on a cross-section of the chip, the cross-section passing through a center of gravity of the discharge surface and being parallel to the axial line, an average A of numbers of crystal grain boundaries of the chip, the crystal grain boundaries being intersected by the first test line, per unit length of the first test line is 20 pieces/mm or more and 400 pieces/mm or less, and an average of lengths of circumferences of crystal grains intersected by the first test line is 6.5 μm or more and 320 μm or less.

A second aspect includes an insulator that has an axial hole extending along an axial line; a center electrode that is disposed in the axial hole; a metal shell that is disposed at an outer periphery of the insulator; and a ground electrode that is connected to the metal shell. At least one of the center electrode and the ground electrode includes a chip that contains Ru as a main constituent, and the chip includes a discharge surface that faces another one of the center electrode and the ground electrode in a direction perpendicular to the axial line. When a first test line that is 10 μm away from the discharge surface is drawn on a cross-section of the chip, the cross-section passing through a center of gravity of the discharge surface and being parallel to a direction in which the other one of the center electrode and the ground electrode faces the discharge surface and parallel to the axial line, an average A of numbers of crystal grain boundaries of the chip, the crystal grain boundaries being intersected by the first test line, per unit length of the first test line is 20 pieces/mm or more and 400 pieces/mm or less, and an average of lengths of circumferences of crystal grains intersected by the first test line is 6.5 μm or more and 320 μm or less.

A third aspect is the first or second aspect in which, when a second test line that is 10 μm away from a side surface that is continuous with the discharge surface is drawn on the cross-section, an average of numbers of crystal grain boundaries of the chip, the crystal grain boundaries being intersected by the second test line, per unit length of the second test line is 20 pieces/mm or more and 400 pieces/mm or less.

A fourth aspect is any one of the first to third aspects in which, when a third test line perpendicular to the first test line is drawn on the cross-section, a value A/B obtained by dividing the average A by an average B of numbers of crystal grain boundaries of the chip, the crystal grain boundaries being intersected by the third test line, per unit length of the third test line is 0.5 or more and 2.0 or less.

A fifth aspect is any one of the first to fourth aspects in which, when a straight line perpendicular to the first test line is drawn on the cross-section and a length of the chip is considered as a length of a shortest line segment among line segments of the straight line cut by boundaries of the chip and when a fourth test line parallel to the first test line is drawn in a range of the chip, the range being half the length of the chip and including the first test line, an average of numbers of crystal grain boundaries of the chip, the crystal grain boundaries being intersected by the fourth test line, per unit length of the fourth test line is 20 pieces/mm or more and 400 pieces/mm or less, and an average of lengths of circumferences of crystal grains intersected by the fourth test line is 6.5 μm or more and 320 μm or less.

A sixth aspect is any one of the first to fifth aspects in which, when a fifth test line parallel to the first test line is drawn in a range of the chip, the range being half the length of the chip and not including the first test line, an average of numbers of crystal grain boundaries of the chip, the crystal grain boundaries being intersected by the fifth test line, per unit length of the fifth test line is 20 pieces/mm or more and 400 pieces/mm or less, and an average of lengths of circumferences of crystal grains intersected by the fifth test line is 6.5 μm or more and 320 μm or less.

A seventh aspect is any one of the first to sixth aspects in which the chip has porosity of 1% or more and 7% or less.

According to the present invention, by configuring such that an average A of numbers of crystal grain boundaries of a chip, the crystal grain boundaries being intersected by a first test line that is 10 μm away from a discharge surface of the chip, per unit length of the first test line is 20 pieces/mm or more and 400 pieces/mm or less and such that an average of lengths of circumferences of crystal grains intersected by the first test line is 6.5 μm or more and 320 μm or less, it is possible to reduce falling-off of the crystal grains near the discharge surface due to oxidation of the crystal grain boundaries and possible to reduce wear of the chip.

### BRIEF DESCRIPTION OF THE DRAWINGS

FIG. 1 is a one-side sectional view of a spark plug in a first embodiment.

FIG. 2 is a sectional view of a part where a center electrode and a ground electrode face each other.

FIG. 3 is a sectional view of a chip of a center electrode.

FIG. 4 is a sectional view of crystal grains intersected by a first test line.

FIG. 5 is a sectional view of a spark plug in a second embodiment.

FIG. 6 is an enlarged sectional view of the part VI of the spark plug in FIG. 5.

### DETAILED DESCRIPTION OF THE INVENTION

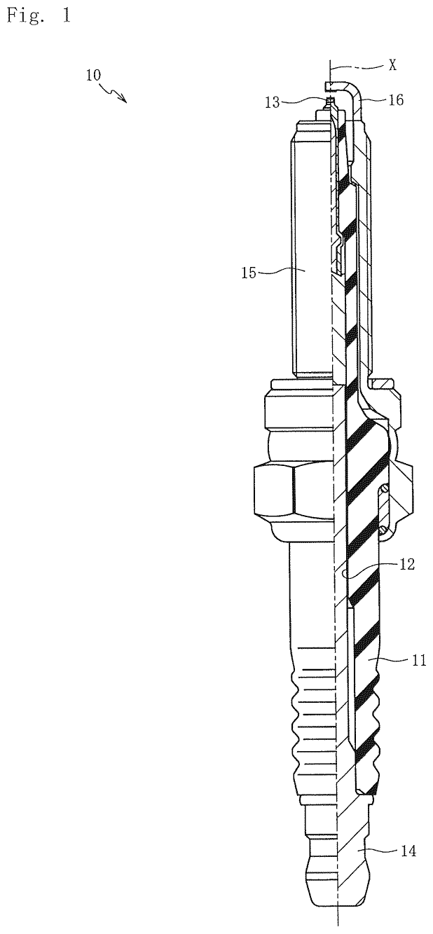

Hereinafter, a preferred embodiment of the present invention will be described with reference to the accompanying drawings. FIG. 1 is a one-side sectional view of a spark plug 10 in the first embodiment with an axial line X as a border. The upper side in FIG. 1 is referred to as the front end side of the spark plug 10, and the lower side in FIG. 1 is referred to as the rear end side of the spark plug 10.

As illustrated in FIG. 1, the spark plug 10 includes an insulator 11, a center electrode 13, a metal shell 15, and a ground electrode 16. The insulator 11 is a substantially cylindrical ceramic member that is made of alumina or the like excellent in mechanical properties and insulation properties under high temperature. The insulator 11 has an axial hole 12 extending along an axial line X through the insulator 11. The center electrode 13 is a rod-shaped electrode disposed along the axial line X in the axial hole 12.

A metal terminal 14 is a rod-shaped member to which an ignition system (not illustrated) is to be connected, and the front end side of the metal terminal 14 is disposed in the axial hole 12 of the insulator 11. The metal terminal 14 is electrically connected to the center electrode 13 in the axial hole 12.

The metal shell 15 is a substantially cylindrical metallic member that is to be fixed to a screw hole (not illustrated) of an internal combustion engine. The metal shell 15 is made of a conductive metal material (for example, low-carbon steel or the like). The metal shell 15 is fixed to the outer periphery of the insulator 11. The ground electrode 16 is connected to the metal shell 15.

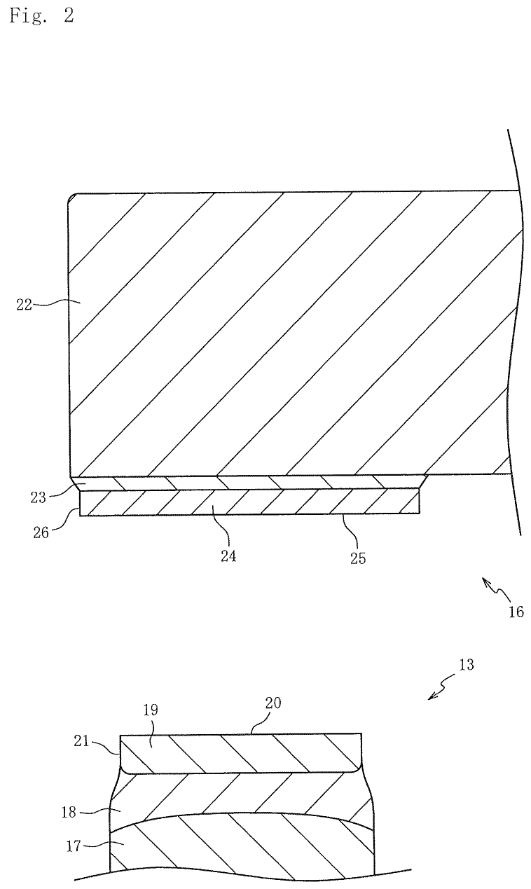

FIG. 2 is a sectional view of a part where the center electrode 13 and the ground electrode 16 of the spark plug 10 face each other. The center electrode 13 includes a base material 17 and a chip 19 provided at a tip of the base material 17.

A core material (not illustrated) excellent in thermal conductivity is embedded in the base material 17. The material of the base material 17 is, for example, Ni or an alloy containing Ni as a main constituent, and the material of the core material is, for example, Cu or an alloy containing Cu as a main constituent. The core material can be omitted.

The chip 19 is sealed to the base material 17 with a molten portion 18. The chip 19 and the base material 17 have melted in the molten portion 18. The molten portion 18 is formed by laser beam welding, resistance welding, diffusion sealing, or the like. The chip 19 includes a discharge surface 20 that faces the ground electrode 16, and a side surface 21 that is continuous with the discharge surface 20.

The ground electrode 16 includes a base material 22 that is connected to the metal shell 15, and a chip 24 that is provided at the base material 22. A core material (not illustrated) excellent in thermal conductivity is embedded in the base material 22. The material of the base material 22 is an alloy containing Ni as a main constituent, and the material of the core material is Cu or an alloy containing Cu as a main constituent. The core material can be omitted. An intermediate member protruding toward the center electrode 13 may be provided at the base material 22, and the chip 24 may be sealed to the intermediate member. The intermediate member is a portion of the base material 22.

The chip 24 is sealed to the base material 22 with a molten portion 23. The chip 24 and the base material 22 have melted in the molten portion 23. The molten portion 23 is formed by laser beam welding, resistance welding, diffusion sealing, or the like. The chip 24 includes a discharge surface 25 that faces the center electrode 13, and a side surface 26 that is continuous with the discharge surface 25.

At least one of the chips 19 and 24 contains Ru as a main constituent. Containing Ru as a main constituent means that, among elements constituting the chip 19 or 24, the element whose content is the largest is Ru. The content of Ru is preferably 50 mass % or more of the amount of all constituents constituting the chip 19 or 24 and is more preferably 60 mass % or more or 70 mass % or more of the amount of the all constituents.

When the chip 19 of the center electrode 13 contains Ru as a main constituent or when the chip 24 of the ground electrode 16 contains Ru as a main constituent, examples of elements other than Ru constituting the chip 19 or 24 are one or more elements selected from Rh, Pd, Os, Ir, Pt, Ta, W, Mo, Nb, Re, Cr, Mn, Fe, Co, Ni, V, Ti, Zr, Hf, Al, and Sc.

When the chip 19 of the center electrode 13 contains Ru as a main constituent, the ground electrode 16 is any one of a ground electrode that includes the chip 24 containing Ru as a main constituent, a ground electrode that includes the chip 24 containing as main constituents one or more of platinum group elements (Rh, Pd, Os, Ir, Pt) other than Ru, and a ground electrode in which the molten portion 23 and the chip 24 are not provided at the base material 22.

When the chip 24 of the ground electrode 16 contains Ru as a main constituent, the center electrode 13 is any one of a center electrode that includes the chip 19 containing Ru as a main constituent, a center electrode that includes the chip 19 containing as main constituents one or more of platinum group elements (Rh, Pd, Os, Ir, Pt) other than Ru, and a center electrode in which the molten portion 18 and the chip 19 are not provided at the base material 17.

The spark plug 10 is formed by, for example, the following method. First, the center electrode 13 is inserted into the axial hole 12 of the insulator 11. Next, after the metal terminal 14 is inserted into the axial hole 12 and electrical continuity between the metal terminal 14 and the center electrode 13 is ensured, the metal shell 15 to which the ground electrode 16 is previously connected is assembled to the outer periphery of the insulator 11. The ground electrode 16 is bent to form a spark gap between the center electrode 13 and the ground electrode 16, thereby obtaining the spark plug 10.

The chips 19 and 24 containing Ru as a main constituent are each formed by, for example, sintering a molded body of metal powder containing Ru, punching a metal plate material containing Ru, or cutting a metal wire material containing Ru. The shape of each of the chips 19 and 24 is not limited, and examples of the shape are shapes of a circular plate, a truncated cone, an elliptical cylinder, and polygonal cylinders such as a triangular cylinder and a quadrangular cylinder.

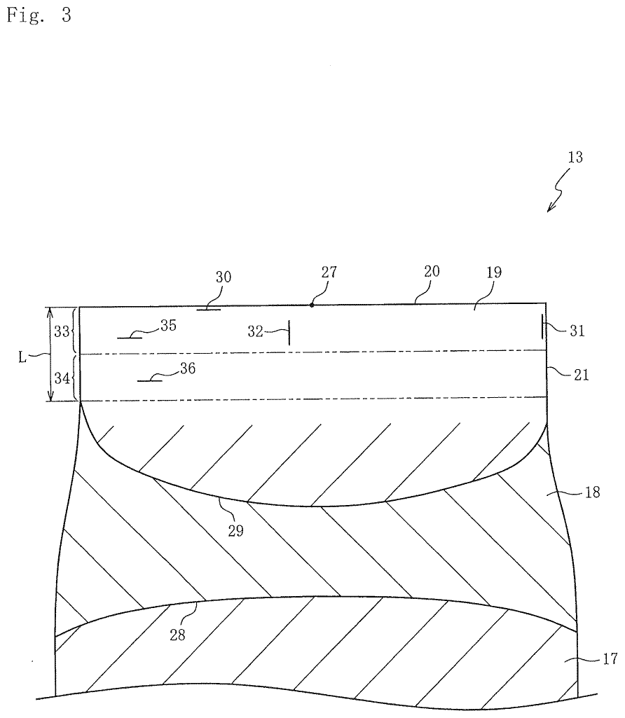

FIG. 3 is a sectional view of the chip 19 of the center electrode 13. In the sectional view in FIG. 3, an example of a scanning electron microscopic (SEM) image of a polished surface of the chip 19 cut parallel to the axial line X at the position of a gravity center 27 of the discharge surface 20 is illustrated. The gravity center 27 of the discharge surface 20 is a centroid when the discharge surface 20 is illustrated as a plane diagram. An interface 28 between the base material 17 and the molten portion 18 and an interface 29 between the molten portion 18 and the chip 19 appear in the cross-section.

For observation of a sectional structure near the discharge surface 20 of the chip 19, a first test line 30 (straight line) that is 10 μm away from the discharge surface 20 is drawn parallel to the discharge surface 20. The distance of 10 μm is provided between the discharge surface 20 and the first test line 30 instead of drawing the test line on the discharge surface 20 since the cross-section of the chip 19 on the discharge surface 20 is deformed (rounded) and decreases accuracy of observation of the sectional structure.

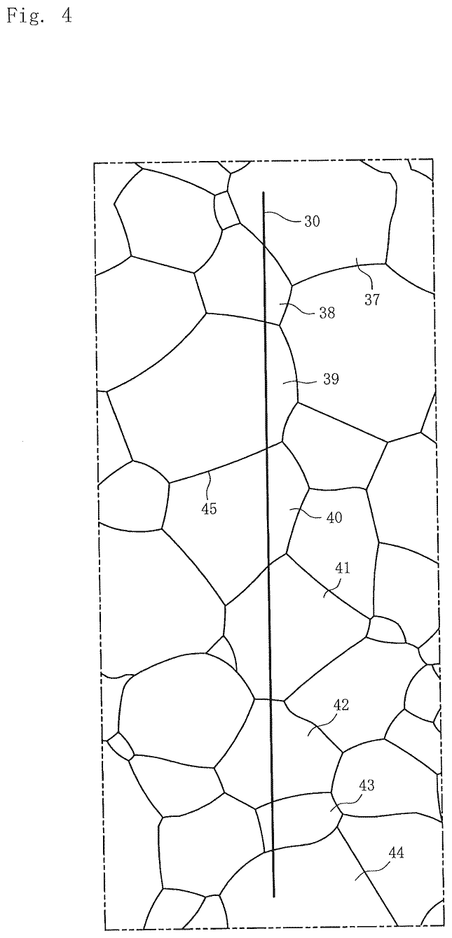

FIG. 4 is a sectional view of crystal grains intersected by the first test line 30. The first test line 30 drawn on the cross-section of the chip 19 intersects crystal grains 38, 39, 40, 41, 42, and 43. The two ends of the first test line 30 end in crystal grains 37 and 44, respectively. The number of intersection points at which the first test line 30 intersects crystal grain boundaries 45 is seven in the present embodiment.

The length of the first test line 30 is set such that the first test line 30 intersects ten or more pieces of crystal grains. The first test line 30 is randomly drawn at various positions in a range that satisfies a condition in which the distance from the discharge surface 20 is 10 μm, and the number of intersection points at which the first test line 30 intersects crystal grain boundaries 45 is counted a plurality of times to obtain an average value of the numbers. The length of the first test line 30 may be changed in each count. The average value is divided by the length of the first test line 30, thereby obtaining an average A (piece/mm) of the numbers of the intersection points of the crystal grain boundaries per unit length. The average A is 20 pieces/mm or more and 400 pieces/mm or less.

An average of lengths of circumferences of the crystal grains 38, 39, 40, 41, 42, and 43 intersected by the first test lines 30 used for obtaining the average A is obtained. In obtaining the average of the lengths of the circumferences, the length of the circumference of each of the crystal grains 37 and 44 in each of which one of the two ends of the first test line 30 ends is not added. The average of the lengths of the circumferences of the crystal grains intersected by the first test line 30 is 6.5 μm or more and 320 μm or less.

Since the crystal grains are large when the average A is small and the number of the crystal grain boundaries is small, there is a trend in which a large thermal stress acts on the crystal grains due to a temperature change in the chip 19 and easily causes falling-off of the crystal grains. When the average A is large and the number of the crystal grain boundaries is large, there is a trend in which oxidation progresses along the crystal boundaries and easily causes falling-off of the crystal grains due to fracture of the crystal grain boundaries. When the average A is 20 pieces/mm or more and 400 pieces/mm or less, it is possible to reduce fracture of the crystal grain boundaries due to oxidation near the discharge surface 20 and also possible to reduce the thermal stress that acts on the crystal grains, and it is thus possible to reduce falling-off of the crystal grains near the discharge surface 20.

When the average of the lengths (the lengths of the crystal grain boundaries) of the circumferences of the crystal grains is short, oxidation of the crystal grain boundaries ends early when oxidation progresses along the crystal grain boundaries, and there is a trend in which falling-off of the crystal grains due to fracture of the crystal grain boundaries occurs early. When the average of the lengths of the circumferences of the crystal grains is long, the crystal grain boundaries have complex shapes. Thus, there is a trend in which a larger thermal stress acts on the crystal grains due to a temperature change in the chip 19 and easily causes falling-off of the crystal grains. When the average A is 20 pieces/mm or more and 400 pieces/mm or less and the average of the lengths of the circumferences of the crystal grains is 6.5 μm or more and 320 μm or less, it is possible to reduce falling-off of the crystal grains near the discharge surface 20 and thus is possible to reduce wear of the chip 19.

FIG. 3 is referred again for description. For observation of a sectional structure near the side surface 21 of the chip 19, a second test line 31 (straight line) that is 10 μm away from the side surface 21 is drawn parallel to the side surface 21. The distance of 10 μm is provided between the side surface 21 and the second test line 31 instead of drawing the test line on the side surface 21 since the cross-section of the chip 19 on the side surface 21 is deformed (rounded) and decreases accuracy of observation of the sectional structure.

The length of the second test line 31 is set such that the second test line 31 intersects ten or more pieces of crystal grains. The second test line 31 is randomly drawn at various positions in a range that satisfies a condition in which the distance from the side surface 21 is 10 μm, and the number of intersection points at which the second test line 31 intersects crystal grain boundaries is counted a plurality of times, as with the first test line 30, to obtain an average value of the numbers. The length of the second test line 31 may be changed in each count. The average value is divided by the length of the second test line 31, thereby obtaining an average (piece/mm) of the numbers of intersection points of the crystal grain boundaries per unit length. The average is preferably 20 pieces/mm or more and 400 pieces/mm or less. Consequently, it is possible to reduce fracture of the crystal grain boundaries near the side surface 21 and also possible to reduce the thermal stress that acts on the crystal grains, and it is thus possible to reduce wear of the chip 19 due to falling-off of the crystal grains near the side surface 21.

For observation of a sectional structure of the chip 19 in a wide range, a plurality of third test lines 32 (straight lines) perpendicular to the first test line 30 are drawn. The number of the third test lines 32 is preferably four to eight. Positions at which the plurality of third test lines 32 are drawn are allocated equally with respect to the length of the discharge surface 20. This is for uniformly observing the sectional structure of the chip 19. The third test lines 32 are preferably drawn in a range between the discharge surface 20 and a position separated by 0.2 mm from the discharge surface 20 toward the interface 29. This is for managing the sectional structure from the discharge surface 20 to the position that is 0.2 mm away from the discharge surface 20.

The length of each of the third test lines 32 is set such that each third test line 32 intersects ten or more pieces of crystal grains. As with the first test line 30, the number of intersection points at which each third test line 32 intersects the crystal grain boundaries is counted a plurality of times to obtain an average value of the numbers. The length of each of the third test lines 32 may be changed in each count. The average value is divided by the length of each third test line 32, thereby obtaining an average B (piece/mm) of the numbers of the intersection points of the crystal grain boundaries per unit length. A value A/B obtained by dividing the average A by the average B is preferably 0.5 or more and 2.0 or less.

A situation in which the value A/B is less than one means that the crystal grains are long in a direction perpendicular to the discharge surface 20, and a situation in which the value A/B is larger than one means that the crystal grains are long in a direction parallel to the discharge surface 20. A situation in which the value A/B is 0.5 or more and 2.0 or less means that the length of each of the crystal grains in the direction perpendicular to the discharge surface 20 and the length of each of the crystal grains in the direction parallel to the discharge surface 20 are substantially equal to each other, and it is possible to reduce the thermal stress that acts on the crystal grains due to a temperature change in the chip 19 and thus is possible to further reduce wear of the chip 19 due to falling-off of the crystal grains.

A straight line perpendicular to the first test line 30 is drawn, and a length L of the chip 19 is considered as the length of a shortest line segment among line segments of the straight line cut by boundaries (the discharge surface 20 and the interface 29) of the chip 19. Since the distance between the interface 29 and the left end (refer to FIG. 3) of the discharge surface 20 is the shortest in the present embodiment, the distance between the left end of the discharge surface 20 and the interface 29 is the length L of the chip 19.

The range of the length L of the chip 19 is divided into a range 33 that is half the length L of the chip 19 and that includes the first test line 30 and a range 34 that is half the length L of the chip 19 and that does not include the first test line 30. A fourth test line 35 parallel to the first test line 30 is drawn in the range 33. The length of the fourth test line 35 is set such that the fourth test line 35 intersects ten or more pieces of crystal grains. As with the first test line 30, the fourth test line 35 is randomly drawn in the range 33, and the number of intersection points at which the fourth test line 35 intersects crystal grain boundaries is counted a plurality of times to obtain an average value of the times. The length of the fourth test line 35 may be changed in each count. The average value is divided by the length of the fourth test line 35, thereby obtaining an average (piece/mm) of the numbers of the intersection points of the crystal grain boundaries per unit length.

When the wear progresses from the discharge surface 20, the range 33 wears first. The average of the numbers of the intersection points of the crystal grain boundaries in the range 33 is preferably 20 pieces/mm or more and 400 pieces/mm or less, and the average of the lengths of the circumferences of the crystal grains intersected by the fourth test line 35 is preferably 6.5 μm or more and 320 μm or less. This is for reducing wear of the chip 19 due to falling-off of the crystal grains by reducing fracture of the crystal grain boundaries in the range 33 and reducing the thermal stress that acts on the crystal grains.

The third test lines 32 may be drawn in the range 33 to obtain the average B (piece/mm) of the numbers of the intersection points of the crystal grain boundaries per unit length and to set such that the value A/B is 0.5 or more and 2.0 or less. This is for reducing wear in the range 33 by reducing the thermal stress that acts on the crystal grains in the range 33 due to a temperature change in the chip 19.

A fifth test line 36 parallel to the first test line 30 is drawn in the range 34. The length of the fifth test line 36 is set such that the fifth test line 36 intersects ten or more pieces of crystal grains. As with the first test line 30, the fifth test line 36 is randomly drawn in the range 34, and the number of intersection points at which the fifth test line 36 intersects crystal grain boundaries is counted a plurality of times to obtain an average value of the times. The length of the fifth test line 36 may be changed in each count. The average value is divided by the length of the fifth test line 36, thereby obtaining an average (piece/mm) of the numbers of the intersection points of the crystal grain boundaries per unit length.

When the wear progresses from the discharge surface 20, the range 34 appears after the range 33 wears. The average of the numbers of intersection points of the crystal grain boundaries in the range 34 is preferably 20 pieces/mm or more and 400 pieces/mm or less, and the average of the lengths of the circumferences of the crystal grains intersected by the fifth test line 36 is preferably 6.5 μm or more and 320 μm or less. This is for lengthening the service life of the chip 19 by reducing fracture of the crystal grain boundaries in the range 34 and reducing the thermal stress that acts on the crystal grains.

The porosity of the chip 19 is preferably 1% or more and 7% or less. The porosity of the chip 19 is a percentage of the areas of pores occupying the area of the SEM image. When the porosity of the chip 19 is 1% or more, the thermal stress due to a temperature change in the chip 19 can be buffered by the pores. The porosity is preferably 1% or more and 7% or less since there is a trend in which oxidation wear of the chip 19 increases when the porosity increases.

When the chip 24 of the ground electrode 16 contains Ru as a main constituent, the average of the numbers of the crystal grain boundaries and the average of the lengths of the circumferences of the crystal grains when the first test line 30, the second test line 31, the third test lines 32, the fourth test line 35, and the fifth test line 36 are drawn on the cross-section of the chip 24 are each included in a range identical to the numerical range described for the chip 19. Consequently, it is possible to reduce wear of the chip 24.

When each of the chips 19 and 24 is to be produced by sintering a molded body of metal powder containing Ru, the sectional structure of each of the chips 19 and 24 can be controlled by particle-diameter distribution of the metal powder and temperature or time of the sintering. When each of the chips 19 and 24 is to be produced by punching a metal plate material containing Ru or cutting a metal wire material containing Ru, the sectional structure of each of the chips 19 and 24 can be controlled by temperature and time of heat treatment of the plate material or the wire material.

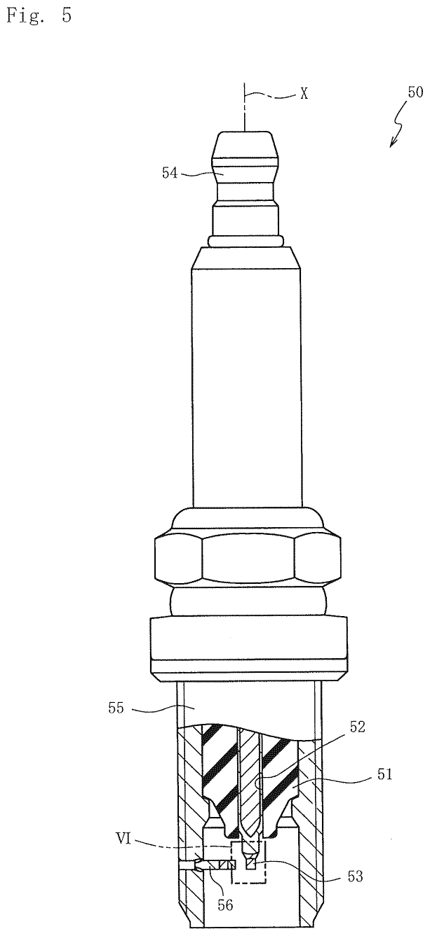

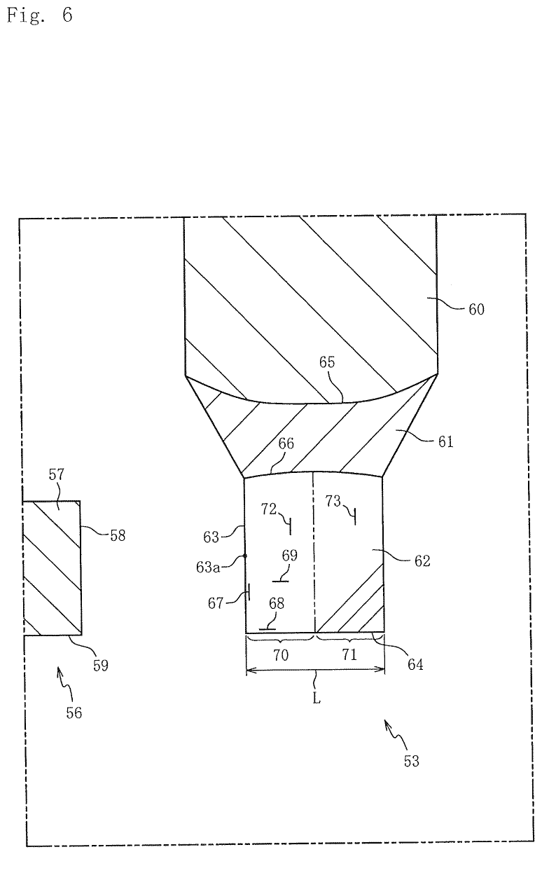

A second embodiment will be described with reference to FIG. 5 and FIG. 6. The first embodiment in which the discharge surface 20 of the chip 19 of the center electrode 13 faces the front end side in a direction parallel to the axial line X and the discharge surface 25 of the chip 24 of the ground electrode 16 faces the rear end side in the direction parallel to the axial line X has been described. In contrast, the second embodiment in which a discharge surface 63 of a chip 62 of a center electrode 53 faces a side in a direction perpendicular to the axial line X and in which a discharge surface 58 of a chip 57 of a ground electrode 56 faces another side in the direction perpendicular to the axial line X will be described.

FIG. 5 is a sectional view of a spark plug 50 in the second embodiment. The lower side in FIG. 5 is referred to as the front end side of the spark plug 50, and the upper side in FIG. 5 is referred to as the rear end side of the spark plug 50. In FIG. 5, illustration of a cross-section of the rear end side of the spark plug 50 is omitted.

53, a metal shell 55, and a ground electrode 56. The insulator 51 is a substantially cylindrical ceramic member that is made of alumina or the like excellent in mechanical properties and insulation properties under high temperature. The insulator 11 has an axial hole 52 extending along the axial line X through the insulator 11. The center electrode 53 is a rod-shaped electrode disposed along the axial line X in the axial hole 12.

A metal terminal 54 is a rod-shaped member to which an ignition system (not illustrated) is to be connected, and the metal terminal 54 is electrically connected to the center electrode 53 in the axial hole 52. The metal shell 55 is a substantially cylindrical metallic (for example, low-carbon steel or the like) member that is to be fixed to a screw hole (not illustrated) of an internal combustion engine. The metal shell 55 is fixed to the outer periphery of the insulator 51. The ground electrode 56 is connected to the metal shell 55.

FIG. 6 is an enlarged sectional view of the part VI of the spark plug 50 in FIG. 5. The ground electrode 56 includes a rod-shaped base material (not illustrated) and the chip 57 sealed to a tip of the base material. The chip 57 includes the discharge surface 58 that faces the center electrode 53, and a side surface 59 that is continuous with the discharge surface 58.

The center electrode 53 includes a base material 60 and the chip 62 provided at a tip of the base material 60. The chip 62 contains Ru as a main constituent. The chip 62 is sealed to the base material 60 with a molten portion 61. The chip 62 and the base material 60 have melted in the molten portion 61. The chip 62 includes the discharge surface 63 that faces the ground electrode 56, and a side surface 64 that is continuous with the discharge surface 63. The discharge surface 63 of the chip 62 and the discharge surface 58 of the chip 57 face each other in a direction perpendicular to the axial line X (refer to FIG. 5).

In the sectional view in FIG. 6, an example of a SEM image of a polished surface of the chip 62 cut perpendicularly to the axial line X at a position of a gravity center 63a of the discharge surface 63 is illustrated. Although the shape of the chip 62 is not limited, when the chip 62 has a cylindrical shape extending in the direction along the axial line X, the discharge surface 63 is a portion (curved surface) of a cylindrical surface. The gravity center 63a of the discharge surface 63 is a centroid of a plane diagram (rectangular in the present embodiment) when the discharge surface 63 is projected in a direction perpendicular to the discharge surface 58 of the chip 57. An interface 65 between the base material 60 and the molten portion 61 and an interface 66 between the molten portion 61 and the chip 62 appear in the cross-section.

For observation of a sectional structure near the discharge surface 63 of the chip 62, a first test line 67 that is 10 μm away from the discharge surface 63 is drawn parallel to the discharge surface 63. For observation of a sectional structure near the side surface 64 of the chip 62, a second test line 68 that is 10 μm away from the side surface 64 is drawn parallel to the side surface 64. In addition, for observation of a sectional structure of the chip 62 in a wide range, a plurality of third test lines 69 perpendicular to the first test line 67 are drawn.

A straight line perpendicular to the first test line 67 is drawn, and a length L of the chip 62 is considered as the length of a shortest line segment among line segments of the straight line cut by boundaries of the chip 62. In the present embodiment, the length of the side surface 64 is the length L of the chip 62. The chip 62 is divided into a range 70 that is half the length L of the chip 62 and that includes the first test line 67 and a range 71 that is half the length L of the chip 62 and that does not includes the first test line 67, a fourth test line 72 parallel to the first test line 67 is drawn in the range 70, and a fifth test line 73 parallel to the first test line 67 is drawn in the range 71.

The average of the numbers of crystal grain boundaries and the average of the lengths of the circumferences of crystal grains when the first test line 67, the second test line 68, the third test lines 69, the fourth test line 72, and the fifth test line 73 are drawn on the cross-section of the chip 62 are each included in a range identical to the numerical range described in the first embodiment. Consequently, it is possible to reduce wear of the chip 62. The same applies to the ground electrode 56 in which the chip 57 contains Ru as a main constituent.

### Example

The present invention will be described more specifically with an example. The present invention is, however, not limited to the example.

### Test 1

An examiner produced cylindrical chips made of a Ru—Pt alloy containing 15 mass % of Pt and the remainder of Ru by powder-metallurgy processing. The dimensions of each chip were set to a diameter of 0.4 mm and a height of 0.4 mm. Various chips having different structures were obtained by varying particle-diameter distribution of powder and sintering temperature. The examiner produced center electrodes in each of which the chip was sealed to a base material, and manufactured each of a plurality of samples No. 1 to No. 17 of a spark plug that is the same as the first embodiment in which a spark gap is provided between a chip of a center electrode and a ground electrode.

After obtained a SEM image of a cross-section of a chip of each of the samples No. 1 to 17, the cross-section passing through the center of gravity of a discharge surface of the chip and being parallel to an axial line, the examiner obtained an average A (piece/mm) of the numbers of crystal grain boundaries per unit length of the first test line, an average (μm) of the lengths of the circumferences of crystal grains intersected by the first test line, an average (piece/mm) of the numbers of crystal grain boundaries per unit length of the second test line, an average B (piece/mm) of the numbers of crystal grain boundaries per unit length of the third test line, and a value A/B obtained by dividing the average A by the average B. The third test line was drawn in a range between a position separated by 0.2 mm from the discharge surface of the chip and the discharge surface. Results of these calculations are shown in Table 1. The porosity of the chip obtained from the SEM image was in the range from 1% to 7%.

The examiner mounted, among the samples No. 1 to No. 17, each of samples other than samples for each of which a SEM image had been obtained onto an engine (displacement 1.3 L) that uses gasoline as a fuel, and performed a test in which the engine was operated for 100 hours in total by repeating an operation in which the engine was operated at the engine revolution of 760 rpm for one minute after the engine was operated at the engine revolution of 3500 rpm for one minute in a state in which an intake throttle valve was fully opened.

After the test, the total (mm) of the wear amount of the discharge surface of the chip of each sample and the wear amount of a side surface of the chip were measured by using a three-dimensional shape measuring machine, and, on the basis of the total wear amount, the samples No. 1 to No. 17 were classified into four ranks from A to D. The A is a rank when the wear amount was less than 0.08 mm, the B is a rank when the wear amount was 0.08 mm or more and less than 0.09 mm, the C is a rank when the wear amount was 0.09 mm or more and less than 0.10 mm, and the D is a rank when the wear amount was 0.10 mm or more. Results are shown in the column of judgement in Table 1.

TABLE 1

| | | First test line | | | | |
|---|---|---|---|---|---|---|
| | First test | Length of | Second | Third test | | |
| | line A | Circumference | test line | line B | | |
| No. | (piece/mm) | (μm) | (piece/mm) | (piece/mm) | A/B | Judgement |
| 1 | 10 | 612 | — | — | — | D |
| 2 | 15 | 421 | — | — | — | D |
| 3 | 20 | 512 | — | — | — | D |
| 4 | 20 | 311 | 11 | — | — | C |
| 5 | 20 | 315 | 20 | 84 | 0.24 | B |
| 6 | 23 | 305 | 25 | 46 | 0.50 | A |
| 7 | 21 | 320 | 21 | 40 | 0.53 | A |
| 8 | 50 | 102 | 34 | 38 | 1.32 | A |
| 9 | 112 | 44.1 | 98 | 101 | 1.11 | A |
| 10 | 198 | 17.2 | 123 | 157 | 1.26 | A |
| 11 | 395 | 6.9 | 398 | 612 | 0.65 | A |
| 12 | 384 | 9.4 | 312 | 193 | 1.99 | A |
| 13 | 398 | 12.5 | 400 | 122 | 3.26 | B |
| 14 | 400 | 6.5 | 810 | — | — | C |
| 15 | 400 | 3.2 | — | — | — | D |
| 16 | 512 | 1.3 | — | — | — | D |
| 17 | 998 | 2.1 | — | — | — | D |

As shown in Table 1, the samples No. 4 to No. 14 in each of which the average A of the numbers of the crystal grain boundaries per unit length of the first test line was 20 pieces/mm or more and 400 pieces/mm or less and in which the average of the lengths of the circumferences of the crystal grains intersected by the first test line was 6.5 μm or more and 320 μm or less were judged as A, B or C while the samples No. 1 to No. 3 and No. 15 to No. 17 in each of which the average A was outside of this range or in which the average of the lengths of the circumferences of the crystal grains intersected by the first test line was outside of this range were judged as B. It was found that it is possible to reduce wear of the chip by configuring such that the average A is 20 pieces/mm or more and 400 pieces/mm or less and such that the average of the lengths of the circumferences of the crystal grains intersected by the first test line is 6.5 μm or more and 320 μm or less.

The samples No. 5 to No. 13 in each of which the average of the numbers of the crystal grain boundaries per unit length of the second test line was 20 pieces/mm or more and 400 pieces/mm or less were judged as A or B while the samples No. 4 and No. 14 in each of which the average of the numbers of the crystal grain boundaries per unit length of the second test line was outside of this range were judged as C. It was found that it is possible to further reduce wear of the chip by configuring such that the average of the numbers of the crystal grain boundaries per unit length of the second test line is 20 pieces/mm or more and 400 pieces/mm or less.

The samples No. 6 to No. 12 in each of which the value A/B was 0.5 or more and 2.0 or less were judged as A while the samples No. 5 and No. 13 in each of which the value A/B was outside of this range were judged as B. It was found that it is possible to further reduce wear of the chip by configuring such that the value A/B is 0.5 or more and 2.0 or less.

### Test 2

The examiner produced cylindrical chips made of a Ru—Pt alloy containing 15 mass % of Pt and the remainder of Ru by powder-metallurgy processing. The dimensions of each chip are set to a diameter of 0.4 mm and a height of 0.4 mm. Based on learning from the relationship between the manufacturing conditions of the chip and the structure of the chip in Test 1, by varying the particle-diameter distribution of powder and sintering temperature, samples No. 18 to No. 20 of a spark plug that is the same as the first embodiment that includes a center electrode including a chip in which the average of the numbers of crystal grain boundaries per unit length of the first test line is 20 pieces/mm were produced, and samples No. 21 to No. 23 of a spark plug that is the same as the first embodiment that includes a center electrode including a chip in which the average of the numbers of crystal grain boundaries per unit length of the first test line is 400 pieces/mm were produced.

The samples No. 20 and No. 23 each include a chip that satisfies “condition 1” in which the average of the numbers of crystal grain boundaries per unit length of the fourth test line is 20 pieces/mm or more and 400 pieces/mm or less and in which the average of the lengths of circumferences of crystal grains intersected by the fourth test line is 6.5 μm or more and 320 μm or less and “condition 2” in which the average of the numbers of crystal grain boundaries per unit length of the fifth test line is 20 pieces/mm or more and 400 pieces/mm or less and in which the average of the lengths of circumferences of crystal grains intersected by the fifth test line is 6.5 μm or more and 320 μm or less. The samples No. 19 and No. 22 each include a chip obtained by subjecting one surface of a cylindrical chip to laser quenching to expand crystal grains near the surface subjected to the laser quenching so that the chip satisfies the condition 1 but does not satisfy the condition 2. The samples No. 18 and No. 21 each include a chip that satisfies neither the condition 1 nor the condition 2.

The examiner conducted the same test as the test 1 on, among the samples No. 18 to No. 23, samples other than samples for each of which an SEM image had been obtained, and measured the wear amount as in Test 1. The service life of each of the samples were estimated on the basis of the wear amount of the sample No. 18, samples whose service life was less than 110% of the service life of the sample No. 18 were judged as A, samples whose service life was 110% or more and less than 120% of the service life of the sample No. 18 were judged as G, and samples whose service life was 120% or more of the service life of the sample No. 18 were judged as E. Results are shown in Table 2. Table 2 shows “M” when the condition was satisfied.

TABLE 2

| | First test | | | |
|---|---|---|---|---|
| | line | Condition | Condition | |
| No. | (pieces/mm) | 1 | 2 | Judgement |
| 18 | 20 | — | — | — |
| 19 | 20 | M | — | G |
| 20 | 20 | M | M | E |
| 21 | 400 | — | — | A |
| 22 | 400 | M | — | G |
| 23 | 400 | M | M | E |

As shown in Table 2, it was found that the service life of each of the samples No. 19, No. 20, No. 22, and No. 23 satisfying the condition 1 can be extended by approximately 10% or more compared with the samples No. 18 and No. 21 not satisfying the condition 1. It was found that the service life of each of the samples No. 20 and No. 23 satisfying the conditions 1 and 2 can be extended by approximately 20% or more compared with the samples No. 18 and No. 21 not satisfying the conditions 1 and 2.

Although the present invention has been described above on the basis of the embodiments, it can be easily assumed that the present invention is not limited at all to the aforementioned embodiments and can be variously improved or modified within a range that does not deviate from the gist of the present invention.

Although the first embodiment in which the ground electrode 16 is bent has been described, the present invention is not limited thereto. It is naturally possible to use, as an alternative to the bent ground electrode 16, the ground electrode 16 having a linear shape. In this case, the front end side of the metal shell 15 is extended in the direction along the axial line, and the linear ground electrode 16 is sealed to the metal shell 15. The number of the ground electrodes 16 is also set, as appropriate.

Although the second embodiment in which the linear ground electrode 56 is used has been described, the present invention is not limited thereto. It is naturally possible to use, as an alternative to the linear ground electrode 56, the ground electrode 56 that is bent. The number of the ground electrodes 56 is also set, as appropriate. It is naturally possible to cover the front end side of the metal shell 55 with a plug cap having a hole extending through the cap in the thickness direction.

### DESCRIPTION OF REFERENCE NUMERALS

10, 50 spark plug
11, 51 insulator
12, 52 axial hole
13, 53 center electrode
15, 55 metal shell
16, 56 ground electrode
17, 60 base material
19, 62 chip
20, 63 discharge surface
21, 64 side surface
27, 63a gravity center
29, 66 interface
30, 67 first test line
31, 68 second test line
32, 69 third test line
33, 34, 70, 71 range
35, 72 fourth test line
36, 73 fifth test line
X axial line

What is claimed is:

1. A spark plug comprising:
an insulator that has an axial hole extending along an axial line;
a center electrode that is disposed in the axial hole;
a metal shell that is disposed at an outer periphery of the insulator; and
a ground electrode that is connected to the metal shell,
wherein at least one of the center electrode and the ground electrode includes a chip that contains Ru as a main constituent,
wherein the chip includes a discharge surface that faces another one of the center electrode and the ground electrode in a direction along the axial line,
wherein, when a first test line that is 10 μm away from the discharge surface is drawn on a cross-section of the chip, the cross-section passing through a center of gravity of the discharge surface and being parallel to the axial line, an average A of numbers of crystal grain boundaries of the chip, the crystal grain boundaries being intersected by the first test line, per unit length of the first test line is 20 pieces/mm or more and 400 pieces/mm or less, and an average of lengths of circumferences of crystal grains intersected by the first test line is 6.5 μm or more and 320 μm or less.

2. The spark plug according to claim 1,
wherein, when a second test line that is 10 μm away from a side surface that is continuous with the discharge surface is drawn on the cross-section, an average of numbers of crystal grain boundaries of the chip, the crystal grain boundaries being intersected by the second test line, per unit length of the second test line is 20 pieces/mm or more and 400 pieces/mm or less.

3. The spark plug according to claim 1,
wherein, when a third test line perpendicular to the first test line is drawn on the cross-section, a value A/B obtained by dividing the average A by an average B of numbers of crystal grain boundaries of the chip, the crystal grain boundaries being intersected by the third test line, per unit length of the third test line is 0.5 or more and 2.0 or less.

4. The spark plug according to claim 1,
wherein, when a straight line perpendicular to the first test line is drawn on the cross-section and a length of the chip is considered as a length of a shortest line segment among line segments of the straight line cut by boundaries of the chip and when a fourth test line parallel to the first test line is drawn in a range of the chip, the range being half the length of the chip and including the first test line,
an average of numbers of crystal grain boundaries of the chip, the crystal grain boundaries being intersected by the fourth test line, per unit length of the fourth test line is 20 pieces/mm or more and 400 pieces/mm or less, and an average of lengths of circumferences of crystal grains intersected by the fourth test line is 6.5 μm or more and 320 μm or less.

5. The spark plug according to claim 4,
wherein, when a fifth test line parallel to the first test line is drawn in a range of the chip, the range being half the length of the chip and not including the first test line, an average of numbers of crystal grain boundaries of the chip, the crystal grain boundaries being intersected by the fifth test line, per unit length of the fifth test line is 20 pieces/mm or more and 400 pieces/mm or less, and an average of lengths of circumferences of crystal grains intersected by the fifth test line is 6.5 μm or more and 320 μm or less.

6. The spark plug according to claim 1,
wherein the chip has porosity of 1% or more and 7% or less.

7. A spark plug comprising:
an insulator that has an axial hole extending along an axial line;
a center electrode that is disposed in the axial hole;
a metal shell that is disposed at an outer periphery of the insulator; and
a ground electrode that is connected to the metal shell,
wherein at least one of the center electrode and the ground electrode includes a chip that contains Ru as a main constituent,
wherein the chip includes a discharge surface that faces another one of the center electrode and the ground electrode in a direction perpendicular to the axial line,
wherein, when a first test line that is 10 μm away from the discharge surface is drawn on a cross-section of the chip, the cross-section passing through a center of gravity of the discharge surface and being parallel to a direction in which the other one of the center electrode and the ground electrode faces the discharge surface and parallel to the axial line, an average A of numbers of crystal grain boundaries of the chip, the crystal grain boundaries being intersected by the first test line, per unit length of the first test line is 20 pieces/mm or more and 400 pieces/mm or less, and an average of lengths of circumferences of crystal grains intersected by the first test line is 6.5 μm or more and 320 μm or less.

8. The spark plug according to claim 7,
wherein, when a second test line that is 10 μm away from a side surface that is continuous with the discharge surface is drawn on the cross-section, an average of numbers of crystal grain boundaries of the chip, the crystal grain boundaries being intersected by the second test line, per unit length of the second test line is 20 pieces/mm or more and 400 pieces/mm or less.

9. The spark plug according to claim 7,
wherein, when a third test line perpendicular to the first test line is drawn on the cross-section, a value A/B obtained by dividing the average A by an average B of numbers of crystal grain boundaries of the chip, the crystal grain boundaries being intersected by the third test line, per unit length of the third test line is 0.5 or more and 2.0 or less.

10. The spark plug according to claim 7,
wherein, when a straight line perpendicular to the first test line is drawn on the cross-section and a length of the chip is considered as a length of a shortest line segment among line segments of the straight line cut by boundaries of the chip and when a fourth test line parallel to the first test line is drawn in a range of the chip, the range being half the length of the chip and including the first test line,
an average of numbers of crystal grain boundaries of the chip, the crystal grain boundaries being intersected by the fourth test line, per unit length of the fourth test line is 20 pieces/mm or more and 400 pieces/mm or less, and an average of lengths of circumferences of crystal grains intersected by the fourth test line is 6.5 μm or more and 320 μm or less.

11. The spark plug according to claim 10,
wherein, when a fifth test line parallel to the first test line is drawn in a range of the chip, the range being half the length of the chip and not including the first test line, an average of numbers of crystal grain boundaries of the chip, the crystal grain boundaries being intersected by the fifth test line, per unit length of the fifth test line is 20 pieces/mm or more and 400 pieces/mm or less, and an average of lengths of circumferences of crystal grains intersected by the fifth test line is 6.5 μm or more and 320 μm or less.

12. The spark plug according to claim 7,
wherein the chip has porosity of 1% or more and 7% or less.
